(19) United States
(12) Patent Application Publication
(10) Pub. No.: US 2003/0198712 A1
(43) Pub. Date: Oct. 23, 2003

(54) Sugar wafer with confectionery filling

(76) Inventors: David Klug, Marysville, OH (US); Leslie Bankirer, Dublin, OH (US)

Correspondence Address: WINSTON & STRAWN, PATENT DEPARTMENT, 1400 L STREET, N.W., WASHINGTON, DC, 20005-3502, US

(21) Appl. No.: 10/448,341

(22) Filed: May 30, 2003

Related U.S. Application Data
(63) Continuation-in-part of application No. 09/837,234, filed on Apr. 18, 2001.

(51) Int. Cl. A23L 1/36

(52) U.S. Cl. 426/93

(57) ABSTRACT

A food product made of a sugar wafer that is preferably cone-shaped having a filling including a mass of a substantially water-free fat-based confectionery material. Also, a process for preparing this product by filling the sugar wafer with the substantially water-free fat-based confectionery material in a molten mass and allowing the filling to harden such as into a non-flowable material in the sugar wafer prior to consumption.

### CROSS-REFERENCE TO RELATED APPLICATIONS

This application is a continuation-in-part of copending application Ser. No. 09/837,234, filed Apr. 18, 2001, the entire contents of which are expressly incorporated herein by reference thereto.

### FIELD OF THE INVENTION

The present invention relates to a food product comprising a sugar wafer having a substantially water-free fat-based confectionery filling and methods of preparing products of such sugar wafers and fillings.

### BACKGROUND OF THE INVENTION

It has long been known that standard fat-based confectionery, such as chocolate, normally melts in the hand on a hot day or if held for too long. In known wafer-containing chocolate or fat-based confections, the chocolate or compound is on the outside of the product, e.g., the Nestlé Kit Kat and Ferrero Roche products, and therefore the problem of the chocolate melting in the hand on a hot day or if held in the hand for too long exists. In these kinds of products where the chocolate is in contact with the hand, undesirable stickiness or dirtying of the hand can often occur.

U.S. Pat. No. 5,709,898 discloses a process for the manufacture of a food product comprising a wafer filled with a food core, the process including the steps of: (i) shaping the food core; (ii) heating at least part of the wafer in order to provide sufficient plastic properties to the wafer to shape; and (iii) shaping the wafer around the pre-shaped food core, the food core acting as a former. Optionally, a barrier coating is either pre-applied to the wafer prior to step (ii) or applied to the shaped food core after step (i). The food core is said to preferably be ice cream.

PCT application WO99/31996 discloses wafers filled with ice cream, mousse, cheese, and vegetables, and states that an inner coating provides the wafer with a sufficient resistance for softening due to moisture or due to the influence from the content. WO99/31996 also states that prior art wafers may be associated with problems, especially for children. If the wafer should have a food core having a certain volume then the cone, the cup or the hollow rod would have too great a dimension, which makes it difficult to handle. Thus, it is difficult to bite off the ice-cream from a large conical ice cream product in the same way as it also will be difficult to bite off the ice-cream that is provided in a cup-shaped wafer.

The foodstuffs disclosed in U.S. Pat. No. 5,709,898 and PCT application WO99/31996 contain substantial amounts of water, hence the desirability of a barrier coating between it and the wafer to prevent undesirable migration of water from the food core to the wafer that would cause the wafer to become soggy.

Thus, it is desired to obtain improvements on these products to obtain a new desirable product that consumers will enjoy consuming, and the present invention provides such improvements.

### SUMMARY OF THE INVENTION

The present invention thus relates to a confectionery product comprising a sugar wafer cone that includes about 10 to 70 weight percent sugar; and a filling that is a substantially water-free fat-based confectionery mass. The mass advantageously comprises: from about 15 to 70 weight percent sugar; an amount of palm stearin sufficient to promote nucleation of fat crystals in a desired crystalline form; from about 0.01 to 25 weight percent non-fat dry milk; flavoring agent present in an amount of about 0.01 to 3 weight percent, and a vegetable fat comprising at least one oil component in an amount sufficient to provide a creamy texture.

In particular, the filling has hardened from a molten mass in the sugar wafer cone prior to consumption, so that the cone keeps a user's hands clean during eating of the product and the product has the appearance of an ice cream cone with the indulgence of a non-frozen fat-based confection. The cone can act as a handle so that the user's hands do not come in contact with the filling. In a preferred embodiment, the filling is dome shaped to provide the appearance of ice cream.

To assist in the retention of the filling in the cone, a fat-based coating can be provided on inner surface(s) of the sugar wafer cone, positioned between the sugar wafer and the filling. In addition to preventing saturation of the sugar wafer by the molten filling during manufacture, the coating can be used to encase inclusions containing substantial amounts of water so that the water does not contact the cone.

In one preferred embodiment, the flavoring agent includes, or is, vanilla or vanillin present in an amount of less than 2 weight percent. In one embodiment, it is vanillin alone and present in an amount from about 0.001 to 0.05 weight percent.

The invention also relates to a process for preparing a confectionery product. This process comprises providing a sugar wafer in a desired shape; introducing a substantially water-free fat-based confectionery filling in a molten mass that flows upon the shaped sugar wafer; and allowing the confectionery mass to harden in the shaped sugar wafer to a non-flowable state under ambient conditions so as to form a confectionery product.

As above, the desired shape of the wafer is conical to keep a user's hands clean during eating of the product and the product combines the appearance of an ice cream cone with the indulgence of a fat-based confection, wherein the molten confectionery mass includes flowable portion that flows to fill and conform to at least part of the cone. The mass can be formulated to be sufficiently hardened or set under ambient temperature in at least about 10 minutes.

### DETAILED DESCRIPTION OF THE PREFERRED EMBODIMENTS

The present invention relates to a food product, and preferably a confectionery product, comprising a sugar wafer having a filling or a substantially water-free fat-based confectionery material. We have found that a sugar wafer cone, normally used for ice cream, can be filled with a substantially water-free fat-based confectionery filling to provide a “handle” that does not melt in hot weather or on prolonged handling, and therefore serves to prevent undesirable stickiness and dirtying of the hands. In addition, this construction does not suffer from water migration problems and provides a product that combines the pleasure and fun of ice cream cones, and the appearance thereof, with the indulgence of a fat-based confection.

Wafers are normally made from batter recipes using from about 20% to 60% by weight of flour, water and sucrose (which may be brown or white) together with smaller quantities of one or more ingredients typically used in a sugar wafer such as fat, milk, cream, milk powder, whole egg, egg powder, soya flour, salt, lecithin, colorant, cocoa powder, flavors, emulsifiers, vanilla crystals, and a raising agent.

The flour is usually wheat flour but it may be another flour such as rice flour or a flour admixed with a starch. Wafers usually have a low fat content, normally around 1% to 2% but in some cases up to 10%, and the main function of the fat is as an antisticking/releasing agent. Sugar wafers as used in this invention differ from standard wafers in that they contain a higher sugar content than that of standard wafers, which is usually less than 5%. The amount of sugar in the sugar wafers of this invention may be from about 10% to 70%, for example from about 12.5% to 50% and more preferably from about 14% to 40% by weight based on the weight of the sugar wafer. Preferably, the sugar wafer is cone-shaped, i.e., with a point or flat bottom like an ice cream cone. All percentages herein are weight percent unless otherwise specified.

The fat-containing confectionery material may be any kind of chocolate, for instance, dark, milk or white chocolate. Chocolate normally has a maximum water content of about 2%, and more usually from about 0.5 to 1.5% by weight. The fat-containing confectionery material may also include products derived from sugar with or without milk derived components, and fat and solids from vegetable or cocoa sources in differing proportions having a moisture content less than 10%, usually less than 5% by weight and more usually less than 2% by weight. The fat containing confectionery material may include chocolate substitutes containing direct cocoa butter replacements or cocoa butter alternatives which are vegetable fats such as cocoa butter equivalents (CBE) or cocoa butter substitutes (CBS) which are well known to those skilled in the art, e.g. CBS laurics and CBS nonlaurics (see Chocolate, Cocoa, and Confectionery; Third Edition, 1989, Bernard W. Minifie; A VI, ppI00-109), e.g., stearins, coconut oil, palm oil, butter or any mixture thereof; nut pastes such as peanut butter flavored filling and fat; peanut butter; praline; confectioner's coatings also known as compound or couvertures, used for covering ice cream or cakes usually comprising chocolate analogues with cocoa butter replaced by a cheaper non-tempering fat; or “Caramac” sold by Nestle comprising non-cocoa butter fats, sugar and milk. For example, the fat-containing confectionery material may be peanut butter, peanut butter flavored filling, or a blend of chocolate and a vegetable fat containing, for instance, from about 60 to 90% chocolate and from about 40 to 10% of a vegetable fat. The vegetable fat is advantageously formed only from non-lauric fat, for example, palm, soy or cottonseed oils, or any combination thereof. Non-lauric fat is preferred over lauric fat due to its greater compatibility with cocoa butter containing chocolate. When peanut butter is included, it can be present in an amount of about 25 to 60 weight percent, preferably from about 30 to 50 weight percent in some embodiments. In one embodiment, these weight percentages of peanut butter flavored filling can be used, and peanut butter forms only a portion thereof. The non-lauric fat is preferred when used in combination with chocolate or other non-lauric fat based coatings. If the cone interior and top are coated with lauric fat based compound/couverture then for compatibility a lauric fat is preferred in the filling.

One or more sugars can be present in the filling in an amount of about 15 to 70 weight percent. Particularly preferred sugars include sucrose, dextrose, or a combination thereof. Sugar is preferably present in some embodiments in an amount from about 18 to 60 weight percent, more preferably in other embodiments from about 20 to 35 weight percent or 30 to 60 weight percent.

If a chocolate-type filling is to be used, the filling will typically include cocoa liquor, cocoa powder, or both. Cocoa liquor, if included, is typically present in an amount of about 2 to 22 weight percent, preferably from about 4 to 20 weight percent. In one embodiment, it is present in 5 to 15 weight percent. Cocoa powder is optionally but typically included in such chocolate-flavor fillings in an amount of about 1 to 10 weight percent, preferably from about 4 to 8 weight percent.

The filling typically contains palm or other stearins individually or in combination. For example, palm stearin can be present in an amount of about 0.01 to 2 weight percent. Other palm components can optionally, but preferably be included in various embodiments in sufficient amounts for different reasons. Palm stearin, when used, is typically added in an amount sufficient to promote the nucleation of fat crystals in the proper crystal form by acting as a crystal seeding agent. Palm kernel stearin is added in an amount sufficient to provide the desired hardness and melting characteristics. Palm kernel stearin is also optionally but preferably present in the filling formulation. Palm kernel stearin can be present in an amount of about 0.01 to 15 weight percent, preferably from about 0.1 to 10 weight percent, and in one preferred embodiment, from about 3 to 7 weight percent.

The filling can optionally include various components depending on the formulation selected. Lactose can optionally be present in an amount of about 0.01 to 7 weight percent, preferably about 0.5 to 5 weight percent when present. Non-fat dry milk, typically in powder form, can be optionally but preferably be present in some embodiments, in amounts of about 0.01 to 30 weight percent, preferably 0.1 to 25 weight percent, and in some more preferred embodiments, from about 1 to 20 weight percent. The non-fat dry milk can be used in an amount of about 5 to 20 weight percent, preferably about 8 to 18 weight percent.

A flavoring agent is present in an amount sufficient to provide flavor to the confectionery product. Flavoring agents include one or more materials present in an amount of about 0.001 to 3 weight percent, preferably from about 0.001 to 2 weight percent. A preferred flavoring agent includes natural or artificial vanilla flavor, i.e., vanilla or vanillin, or both, present in a total amount of about 0.01 to 2 weight percent. Vanilla can optionally be present in an amount of about 0.001 to 2 weight percent, preferably from about 0.01 to 2 weight percent, and in a more preferred embodiment from about 0.1 to 2 weight percent of the total filling composition. Vanillin can optionally be present in an amount of about 0.001 to 2 weight percent, preferably from about 0.001 to 0.1 weight percent, and in a more preferred embodiment from about 0.005 to 0.05 weight percent.

Various other oils, fats, or both can be included in types and amounts sufficient to obtain a creamy texture in the filling. Such oils and fats include, but are not limited to, cocoa butter equivalents (CBEs), cocoa butter replacers (CBRs), cocoa butter substitutes (CBSs), palm oil, sunflower oil, canola oil, coconut oil, cocoa butter, hazelnut oil or paste, canola oil, palm kernel oil, peanut oil or paste, or the like. The optional oil component can be present in an amount of about 0.01 to 40 weight percent. In some embodiments, the oil is present in an amount of about 5 to 30 weight percent, preferably from about 10 to 25 weight percent. For example, palm kernel oil can be included in an amount of 0.01 to 30 weight percent and peanut oil can be included in an amount of about 0.01 to 10 weight percent, as these two oils are particularly compatible.

The confectionery mass preferably includes less than about 25 weight percent yogurt or yogurt powder. Yogurt can be optionally added in the form of yogurt powder, such as in an amount of about 10 to 25 weight percent. In one embodiment, yogurt powder can be present in an amount of about 5 to 30 percent, while in another is it 12 to 20 weight percent. Particularly when yogurt is present, fruit powder (dehydrated or not) can be included, such as in an amount of about 1 to 10 weight percent. In one embodiment, the food product is essentially free, preferably completely free, of yogurt and yogurt powder. Various other types and suitable amounts of optional ingredients can be included in the filling as desired, such as whole milk powder, whey powder, salt, anti-oxidants, or the like.

In some embodiments, it is desired to provide a lighter, softer filling using aeration either from gas injection or whipping of the component. Preferably, the filling density before aeration is from about 1.15 g/cm³ to 1.25 g/cm³. After aeration, the aerated filling typically has a density of about 0.75 g/cm³ to 1.1 g/cm³, a reduction of from about 5 to 40%. Aeration facilitates providing the light, creamy texture desired in some embodiments of the filling of the invention.

The food product may have a weight from 5 to 40 grams. Within this range, the product may be bite-sized weighing from 5 to 15 grams or a 2-3 bite piece weighing from above 15 grams to 40 grams, preferably from 20 to 30 grams.

When the food product is bite-sized or a 2-3 bite piece, there are the following advantages:

1) There are no handling and biting difficulties as in prior art wafers because the diameter of the top of the cone is sufficiently small to fit into one's mouth for biting the filling. In this respect, PCT patent application WO 99/31996 teaches away from the present invention by stating that these difficulties can be solved by using a fan-shaped wafer instead of a cone-shaped wafer as in our invention.

2) The cone serves to keep the hands clean during eating.

3) Traditionally, fillings are in a chocolate or compound shell. When these fillings are fat-based, care must be taken to avoid fat migration from the filling to the shell material. This is a normal problem when the filling contains a high proportion of liquid fat at room temperature. When the fat migrates from the filling to the shell there is a tendency towards softening the chocolate or compound shell. This is important as soft creamy fillings are especially appreciated by the consumer but soft shells are not. Many cases of fat migration to the shell are known by those familiar with the art. Center fillings made with nut pastes show a high tendency of having migration problems (e.g., Reese's Peanut Butter Cups). One method of combat is to remove a portion of the nut oil by pressing (i.e., reduced-fat peanut flours). The resulting products do not have the same fresh flavor as full fat nut pastes. By encasing our fillings in a wafer, this problem is avoided, allowing us to have higher percentages of liquid oil promoting a soft creamy texture as well as allowing the incorporation of high levels of full fat nut pastes without the worry of having a soft and messy chocolate shell.

Optionally, edible inclusions such as chopped nuts, candy pieces, fruit pieces such as raisins, etc. may be the incorporated in the fat-containing confectionery material.

Any inclusions containing substantial amounts of water are preferably encased within the fat-containing confectionery material.

Optionally, a fat-based coating is applied to the inside surface of the sugar wafer to enhance the flavor of the food product.

If desired, the food product may have a topping of chocolate or confectionery coating. Optionally, edible inclusions such as chopped nuts, candy pieces, raisins or other fruit pieces, etc. may be added to the topping.

The present invention also provides a process of preparing a food product comprising a sugar wafer having a substantially water-free fat-based confectionery filling which comprises filling the sugar wafer with the substantially water-free fat-based confectionery in a molten, semi-liquid or semi-solid mass, i.e., flowable state, and allowing the filling to harden, e.g., to a non-flowable state. The filling material is provided into the sugar wafer having the desired shape by any suitable means known to those of ordinary skill in the art, including by depositing or inserting the filling into the shaped sugar wafer. This can preferably be accomplished with a nozzle, sprayer, extruder, co-extruder, or the like. The filling can be molded by flowing into the sugar wafer and taking the shape of the interior space thereof. Co-extruded fillings are also possible according to the invention, preferably with each layer or swirl of the co-extruded filling having a different color, texture, sweetness, or some combination thereof.

Advantageously, a coating of chocolate or compound is first applied to the inside of the wafer. This may be performed either by filling the wafer with the chocolate or compound in a molten state and then inverting the wafer, optionally with vibration, to empty excess coating or preferably by spraying the coating of chocolate or compound onto the inside surface of the wafer. Afterwards, the coating is optionally allowed to harden first and the coated wafer is then filled with a molten, semi-liquid or semi-solid mass of another fat-based confectionery material, optionally with edible inclusions incorporated therein, which is subsequently allowed to harden.

The method of the invention provides or introduces filling in a molten state into the sugar wafer cone, which has been pre-shaped. “Molten” refers to a semi-solid, semi-liquid, or entirely liquid state whereby the confectionery material is flowable and can conform to the shape of a container into which it is introduced. “Semi-solid” refers to a material that is predominantly solid but has some liquid present in a minor amount of less than 50%. “Semi-liquid” is the converse, a material that is predominantly liquid with minor amounts of less than 50% solid present. In either situation, the term “molten” means that some liquid oil/fat content is present to facilitate the flow of the confectionery mass. The molten confectionery mass of the present invention flows into the shaped sugar wafer so that a portion of the molten mass conforms to the shape of the sugar wafer. This confectionery mass shape opposes the portion of the inside of the shaped sugar wafer that it contacts so as to form a second desired shape, e.g., a top on the sugar wafer that is domed, at least substantially cylindrical or conical, tetrahedral/pyramidal, or the like. Preferably, substantially all of the inside of the sugar wafer contacts some of the molten mass, i.e., at least about 60 percent, preferably at least about 75 percent, and more preferably at least about 85 percent of the inside of the sugar wafer contacts the confectionery filling material/mass.

Over time after being introduced into the shaped sugar wafer, the filling hardens sufficiently into the second desired shape to inhibit flow thereof. This time period will depend on the confectionery material selected, but is typically less than about 30 minutes, preferably less than about 10 minutes, and more preferably less than about 2 minutes under ambient conditions. The confectionery material does not necessarily harden to a solid, although it can. Preferably, it hardens sufficient to inhibit the flow thereof, which advantageously permits easy deposition into the wafer during formation while permitting the confectionery material to retain its second desired shape. Preferably, the flow is sufficiently inhibited before and through consumption to inhibit or prevent dripping or flowing even while being warmed in the hand of a consumer.

The molten state can be achieved through heat sufficient to melt or partially melt the fat, and the fat can be partially crystallized to help solidify the confectionery material after the heat source is removed. Removal of the heat source(s) optionally but preferably used during the providing of the filling material into the cone facilitates the hardening to a non-flowable state, which can begin at any lowered temperature but which hardening fully occurs under ambient conditions. In one embodiment, the confectionery mass is solid under ambient temperature. Preferably, however, the confectionery mass has a soft, creamy texture that is sufficiently rigid to hold its shape within the encasement of the cone and chocolate or coating under ambient conditions.

### EXAMPLES

The following Examples further illustrate the present invention. Products according to the invention can be made by hand or in automated fashion.

### Example 1

A Food Product According to the Invention

A bite-size product weighing 12.9 grams is prepared from a sugar wafer cone weighing 3.2 grams, filling with liquid compound coating having a fat component of partially hydrogenated palm kernel oil and emulsifier (lactic acid esters of mono glycerides), inverting the cone and applying a vibration to empty leaving a thin layer of compound coating weighing 1.6 grams on the inside surface of the cone. Optionally, the interior of the cone can be sprayed with the coating instead thus eliminating the need to invert the cone to empty excess coating. The coating is optionally allowed to harden before filling, and the sugar wafer cone is filled with 6 grams of a semi-solid peanut butter mass comprising 25% peanut butter and 39% white compound coating with a fat composition of fractionated palm kernel oil and palm stearin encasing 36% of candy pieces sized by sifting through U.S. Standard Sieves using pieces that go through a 5 mesh sieve and retained on a 12 mesh sieve. Preferably, the filling is flowed into the sugar wafer before the coating hardens. The composition of the candy pieces is as follows: Sugar, Corn syrup, Ground Roasted Peanuts, Partially Hydrogenated Palm Kernel Oil, Cocoa, Molasses, Confectioner's Corn Flakes, Skim Milk, Whey, Salt, Monoglycerides, Soy Lecithin, Cornstarch, Artificial Flavors, Yellow 5, TBHQ and Citric Acid (to preserve freshness), Red 40. The top of the filling is domed to appear similar to an ice cream cone. The filling is allowed to harden and, optionally, the filled cone is dipped into a molten chocolate flavored compound coating, or sprayed with a molten chocolate flavored compound coating, or a chocolate flavored compound coating can be deposited over the filling resulting in either total or partial coverage of the filling. This dipping, spraying, or depositing can be accomplished either before or after the filling is allowed to harden, preferably before. The dosage of the chocolate flavored compound coating is approximately 1 gram. The chocolate compound coating contains sugar, partially hydrogenated palm kernel oil, cocoa solids, butter milk solids, soy lecithin, salt, ethyl vanillin (moisture less than 1%) and then immediately dipped into 1.1 grams candy pieces. Optionally, the candy pieces can be sprinkled over the still-molten, i.e., flowable, chocolate flavored compound coating. For all of the food products of the invention, it is preferred that the entire product be prepared before any of the materials used therein fully harden when an automated type process is used.

The product obtained combines the pleasure of ice cream cones with the indulgence of a fat based confection.

### Example 2

A Food Product According to the Invention

A 2-3 bite product weighing 28.1 grams is prepared from a sugar wafer cone weighing 5.1 grams, filling with liquid compound coating having a fat component of partially hydrogenated palm kernel oil and emulsifier (lactic acid esters of monoglycerides), inverting the cone and applying a vibration to empty leaving a thin layer of compound coating weighing 3.2 grams on the inside surface of the cone. Optionally, the interior of the cone can be coated by spraying the interior of the cone with the compound coating, eliminating the need to invert the cone to empty excess coating. Optionally, the coating is allowed to harden before the sugar wafer cone has filling introduced. The sugar wafer cone is filled with 9.9 grams of a semi-solid peanut butter mass comprising 45% peanut butter and 55% white compound coating with a fat composition of Fractionated Palm Kernel Oil and Palm Stearin, encasing 2.0 grams of caramel. The top of the filling is domed to appear similar to an ice cream cone. The filling is allowed to harden and the filled cone is dipped into 1.6 grams of a chocolate compound coating containing sugar, partially hydrogenated palm kernel oil, cocoa solids, butter milk solids, soy lecithin, salt, ethyl vanillin (moisture less than 1%) and then immediately dipped into 2.3 grams of chopped peanuts followed by a second dipping into 4.0 grams of a chocolate compound coating. Either or both dippings can occur before or after the filling is allowed to harden, preferably before hardening.

The product obtained combines the pleasure of ice cream cones with the indulgence of a fat based confection while being easy to handle and bite.

### Example 3

A Food Product According to the Invention

A single bite-size product weighing 11.5 grams is prepared from a sugar wafer cone weighing 3.4 grams, filling with 7.0 grams of a tempered semi-solid mass comprising a blend of 72% milk chocolate and 18% of a non-lauric vegetable fat (partially hydrogenated cottonseed and soybean oil) and 10% crisped rice, doming to give the appearance of an ice cream cone and allow to harden. Finally, the filled cone is dipped in 1.1 grams of tempered milk chocolate to coat the tops.

The product obtained combines the pleasure of ice cream cones with the indulgence of a fat based confection while being easy to handle and bite.

### Example 4

A Peanut Butter Flavored Filling According to the Invention

A peanut butter-based filling can be prepared according to the invention having a soft, creamy texture.

| Peanut Butter Flavored | Weight percent |
|---|---|
| Filling Component | range |
| Sucrose | 18 to 35 |
| Lactose | 0 to 7 |
| Palm Kernel Stearin | 0 to 15 |
| Palm Kernel Oil | 0.15 |
| Palm Stearin | 0 to 2 |
| Non-Fat Dry Milk | 8 to 20 |
| Vanillin | 0 to 0.02 |
| Salt | 0 to 1 |
| Peanut Butter | 25 to 60 |

### Example 5

A Chocolate-Based Filling According to the Invention

A chocolate-based filling can be prepared according to the invention having a soft, creamy texture.

| Chocolate | Weight percent |
|---|---|
| Filling Component | range |
| Sucrose | 30 to 60 |
| Non-Fat Dry Milk | 10 to 30 |
| Cocoa Liquor | 0 to 22 |
| Cocoa Powder | 0 to 10 |
| Coconut Oil | 10 to 30 |
| Palm Stearin | 0 to 2 |
| Vanillin | 0 to 0.05 |

### Example 6

A White Filling According to the Invention

A white filling can be prepared according to the invention having a soft, creamy texture.

| White | | |
|---|---|---|
| Filling Component | Vanilla Flavor (wt %) | Yogurt/Fruit Flavor (wt %) |
| Sucrose | 15 to 55 | 15 to 50 |
| Non-Fat Dry Milk | 0 to 25 | 0 to 20 |
| Lactose | 0 to 7 | 0 to 5 |
| Dextrose | 0 to 15 | 0 to 10 |
| Palm Kernel Stearin | 0 to 10 | 0 to 10 |
| Palm Kernel Oil | 0 to 30 | 0 to 20 |
| Palm Stearin | 0 to 2 | 0 to 2 |
| Peanut Oil | 0 to 30 | 0 to 30 |
| Vanillin or Vanilla | 0 to 2 | 0 to 2 |
| Yogurt Powder | — | 10 to 25 |
| Dehydrated Fruit | — | 1 to 10 |
| Powder | | |
| Flavorings | — | 0 to 2 |

Either a vanilla-based white filling or a fruity-type white filling can be prepared according to the invention to obtain the surprising and unexpected advantage of a food product having a true fat-based confectionery composition that is at least substantially water free. In each of Examples 4-6, the filling is deposited within a sugar wafer cone of the invention to provide a confectionery treat having the appearance of an ice cream cone but the pleasure of a fat-based confectionery that does not melt or drip at ambient temperature.

The term “hardened” as used herein, refers to a flowable material that is no longer flowable under ambient conditions over a 10 minute period of time. This hardening change is physical in nature and not from a chemical reaction, and occurs due to a sufficient increase in viscosity and/or thickening and/or partial or complete phase-transition from a flowable material to a non-flowable material. For example, ice cream cannot be hardened according to the invention because it will become flowable due to melting over 10 minutes at ambient temperature.

The term “substantially water-free,” as used herein, refers to a water content of less than about 10 weight percent, preferably no more than about 5 weight percent, and more preferably no more than about 2 weight percent. In a preferred embodiment, the filling contains no more than about 1 weight percent water, preferably no more than about 0.1 weight percent water. “Water-free” or “completely water-free” means that excess water is preferably not included in the filling of the invention. Preferably, there is no water content in the filling other than trace moisture that is inherent in any food product exposed to ambient humidity.

The term “about,” as used herein, should generally be understood to refer to both numbers in a range of numerals. Moreover, all numerical ranges herein should be understood to include each whole integer within the range. The total of all percentages of the components of any given filling is 100 weight percent.

Although preferred embodiments of the invention have been described in the foregoing Detailed Description of the Preferred Embodiments, it will be understood that the invention is not limited to the embodiments disclosed but is capable of numerous rearrangements and modifications of parts and elements without departing from the spirit of the invention. It will be understood that the chemical or other details of every design and embodiment may be slightly different or modified by one of ordinary skill in the art without departing from the blends and methods taught by the present invention.

What is claimed is:

1. A confectionery product comprising:
a sugar wafer cone that includes about 10 to 70 weight percent sugar; and
a filling that is a substantially water-free fat-based confectionery mass comprising:
from about 15 to 70 weight percent sugar;
an amount of palm stearin sufficient to promote nucleation of fat crystals in a desired crystalline form;
from about 0.01 to 25 weight percent non-fat dry milk;
a flavoring agent present in an amount sufficient to provide flavoring but in an amount no more than about 3 weight percent; and
a vegetable fat comprising at least one oil component in an amount sufficient to provide a creamy texture;
wherein the filling has hardened from a molten mass in the sugar wafer cone prior to consumption, so that the cone keeps a user's hands clean during eating of the product and the product has the appearance of an ice cream cone with the indulgence of a non-frozen fat-based confection.

2. The product of claim 1, wherein the filling has a water content of less than about 1 weight percent and the filling has less than about 25 weight percent yogurt or yogurt powder.

3. The product of claim 1, wherein the filling comprises from about 40 weight percent to 10 weight percent of the vegetable fat in combination with about 5 weight percent to 50 weight percent of a chocolate component comprising cocoa liquor and cocoa powder, or any mixture thereof.

4. The product of claim 3, wherein the filling is a blend of chocolate and non-lauric vegetable fat.

5. The product of claim 4, wherein the sugar wafer cone comprises 20 to 60 weight percent flour and a top portion of the filling is dome shaped to provide the appearance of ice cream.

6. The product of claim 1, wherein the vegetable fat comprises about 25 weight percent to 65 weight percent nut paste combined with about 30 weight percent to 60 weight percent of a confectionery compound coating and optionally about 5 weight percent to 40 weight percent of one or more solid inclusions.

7. The product of claim 1, wherein the vegetable fat comprises peanut oil in an amount of about 0.01 to 30 weight percent, the sugar comprises sucrose and dextrose, and the filling further comprises 0.01 weight percent to 40 weight percent of palm kernel stearin and palm kernel oil together in combination.

8. The product of claim 1, which further comprises a fat-based coating on inner surface(s) of the sugar wafer cone and positioned between the sugar wafer and the filling.

9. The product of claim 1, wherein edible inclusions are incorporated in the fat-based confectionery mass and any inclusions containing substantial amounts of water are encased within the fat-based confectionery mass.

10. The product of claim 8, wherein the edible inclusions are chopped nuts, candy pieces, raisins, or any mixture thereof.

11. The product of claim 1, which further comprises a topping of chocolate, a confectionery coating, chopped nuts, candy pieces, raisins or any mixture thereof.

12. The product of claim 1, wherein the filling is sufficiently aerated to decrease the density thereof by at least about 0.15 to 0.5 g/cm³.

13. A process for preparing a confectionery product which comprises:
providing a sugar wafer in a desired shape;
introducing a substantially water-free fat-based confectionery filling in a molten mass that flows upon the shaped sugar wafer; and
allowing the confectionery mass to harden in the shaped sugar wafer to a non-flowable state under ambient conditions so as to form a confectionery product,
wherein the confectionery mass comprises:
from about 15 to 70 weight percent sugar;
an amount of palm stearin sufficient to promote nucleation of fat crystals in a desired crystalline form;
from about 0.01 to 25 weight percent non-fat dry milk;
a flavoring agent present in an amount sufficient to provide flavoring but in an amount no more than about 3 weight percent; and
a vegetable fat comprising at least one oil component in an amount sufficient to provide a creamy texture.

14. The process of claim 13, wherein the desired shape is conical to keep a user's hands clean during eating of the product and the product combines the appearance of an ice cream cone with the indulgence of a fat-based confection, wherein the molten confectionery mass includes flowable portion that flows to fill and conform to at least part of the cone.

15. The process according to claim 14, wherein a fat-based coating is applied to inner surface(s) of the cone before the confectionery mass is disposed therein.

16. A process according to claim 14, wherein edible inclusions are incorporated in the fat-based confectionery mass.

17. A process according to claim 17, wherein the edible inclusions are chopped nuts, candy pieces, raisins, or any mixture thereof.

18. A process according to claim 14, which further comprises forming a top portion of the filling into a dome to provide the appearance of an ice cream cone and providing a topping of chocolate, a confectionery coating, chopped nuts, candy pieces, raisins or any mixture thereof.

19. The process of claim 14, wherein the introducing comprises disposing molten mass into the shaped sugar wafer.

20. A process for providing a confectionery product which comprises:
forming a sugar wafer in a desired shape;
inserting a substantially water-free fat-based confectionery in a molten mass upon the shaped sugar wafer so that a portion of the mass flows to conform to the shape of the sugar wafer, wherein the confectionery mass comprises:
from about 15 to 70 weight percent sugar;
an amount of palm stearin sufficient to promote nucleation of fat crystals in a desired crystalline form;
from about 0.01 to 25 weight percent non-fat dry milk;
a flavoring agent present in an amount sufficient to provide flavoring but in an amount no more than about 3 weight percent; and
a vegetable fat comprising at least one oil component in an amount sufficient to provide a creamy texture; and
solidifying the flowable confectionery mass sufficiently to form a substantially water-free fat-based confectionery filling mass in a second desired shape that corresponds to the desired shape of the sugar wafer and which is sufficiently hardened to retain the second desired shape under ambient temperature for at least about 10 minutes.
